(19) United States
(12) Patent Application Publication
(10) Pub. No.: US 2009/0228466 A1
(43) Pub. Date: Sep. 10, 2009

(54) METHOD OF AND DEVICE FOR SEARCHING FOR RELEVANT CONTENT IN A NETWORK

(75) Inventors: Marc Andre Peters, Eindhoven (NL); Wilhelmus Henrica Gerarda Maria Van Den Boomen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,452

(22) PCT Filed: Jul. 22, 2005
(86) PCT No.: PCT/IB2005/052471

§ 371 Date: Feb. 9, 2007

(30) Foreign Application Priority Data
Aug. 11, 2004 (EP) 04103865.4

(51) Int. Cl. G06F 17/30

(52) U.S. Cl. 707/5; 707/E17.108

(57) ABSTRACT

This invention relates to a method of and a device for searching for relevant content that automatically obtains related information for a digital content item currently being rendered, played, viewed, accessed or selected on an audio/video device (e.g. a HD recorder). The obtained related information is used to automatically search for groups of a network (e.g. a P2P network) comprising said digital content item.

The invention relates to a method of searching for relevant content.

The invention further relates to a device for searching for relevant content.

Further, the invention relates to a computer readable medium having stored thereon instructions for causing one or more processing units to execute the method of searching for relevant content.

In a peer-to-peer (P2P) network environment comprising audio/video devices, like HD recorders, PVRs/PVSs (Personal Video Recorders/Personal Video Stations), DVB (Digital Video Broadcasting) systems, DVRs (Digital Video Recorders), PTRs (Personal TV Receivers), DVD/CD recorders/players, etc., content items are typically published in groups and shared among the devices of the peer-to-peer network. Examples of groups are genre groups like comedy, news, action, etc., security groups i.e. a group that share content not allowed (and accessible) by people not belonging to the group, user specified groups like my_home_videos, interest groups like my_tennis_club, sport, and so on.

A peer-to-peer (P2P) network is a type of network where each node, computer, workstation, or the like in the network mostly has similar capabilities with respect to client/server functionality, which is different from the more traditional client/server structure where some nodes, computers, etc. are dedicated to serving others. The structure of P2P networks is therefore simpler and often more de-centralised, ‘loose’ or ad-hoc in its nature.

A content item may be any one of several types of content, such as television programs/shows, movies, radio programs, audio and/or video tracks, MPEG-4 objects, scenes, images, music, etc.

The content items (forth only denoted content) and groups are typically both annotated with metadata for example keywords in the well-known TV Anytime data format, the well-known MPEG 7 Multimedia Description Scheme (MDS)/MPEG 7 Standard or in general pairs of attributes and values, etc.

In the prior art, when a user wants to find content and/or groups (comprising similar content) being present in the network then a search is conducted on this metadata to locate content items and/or groups he/she is looking for.

However, with a rapidly increasing amount of content and groups it can be a very arduous, time-consuming and/or difficult task for a user to locate or find interesting groups and/or content.

Use of metadata queries to search for contents is known from De Jong F.: “Share it! Deliverable#3: Description of example applications”, 2 Dec. 2002, pages 1-93, XP002292778.

US2003/0191753 discloses searching content at one or more nodes of a community in which the results are filtered based on personal criteria.

Use of the CRID of a currently viewed program to obtained associated metadata for searching like programs is known from Tol R.: “TV-anytime, Specification series: S-2 on: System description (informative with mandatory appendix B)” THE TV-ANYTIME FORUM, [Online] 5 Apr. 2002, pages 1-39, XP002292779.

WO2004/054201 discloses performing a search for content items on a peer-to-peer network.

It is an object of the invention to provide a method of and a device for searching for relevant content that solves (among others) the above-mentioned shortcomings of prior art. A further object is to provide this in a simple, flexible and efficient way.

These objects, among others, are achieved by a method of searching for relevant content, said content having related information associated therewith, said method comprising the steps of: automatically obtaining related information associated with a digital content item currently being rendered or selected on an audio/video device, and establishing a communications connection with at least one additional audio/video device via a network, and using said related information to automatically search via said additional audio/video device for groups, said groups comprising a plurality of digital content items having at least one characteristic in common, wherein said search is initiated in the background when rendering or selection of the content item is started so that a result of said search is ready when a user requests the result or at least likely to be ready when a user requests the result.

These object, among others, are achieved by a device for searching for relevant content, said content having related information associated therewith, said device comprising: means for automatically obtaining related information associated with a digital content item currently being rendered or selected on an audio/video device, and a communications transceiver for establishing a communications connection with at least one additional audio/video device via a network, and means for using said related information to automatically search via said additional audio/video device for groups, said groups comprising a plurality of digital content items having at least one characteristic in common, wherein said search is initiated in the background when rendering or selection of the content item is started so that a result of said search is ready when a user requests the result or at least likely to be ready when a user requests the result.

In this way, it is possible to provide a user with groups and/or content that to a high degree interests the user based on the content item the user currently is viewing, since information for the currently watched content on a given audio/video device is used to search for groups comprising the same content item (or copy thereof). Such groups should contain content that to a high degree also would interest the user.

Further, a user is automatically provided with an increased opportunity to find content and/or groups of his/her liking in a network without performing the task himself, which may be difficult if searching among a large amount of content and/or groups perhaps stored on many different devices.

Furthermore, it is also possible to provide a user with related content significantly faster as the search is already done in advance or started as soon as possible.

In one embodiment, the method further comprises, when a user manually initiates a search for one or more content items and/or groups where the search comprises one or more fields to search for, the step of specifying one or more initial values for each field using said related information, where the user may, for each field, select among the initial values if more than two initial values for a single field and/or may de-select the use of initial values for a single field.

In this way, a user can easily (de)select the relevant options. I.e. the user only has to modify the proposed search fields by specifying to include a given field in the search or not. This modification or deselecting/selecting can be done by a very simple user interface and without the use of a keyboard or similar complex input device for getting input. This is especially useful for devices being operated by simpler means, such as a remote control or the like.

In one embodiment, the step of using said related information to automatically search for groups comprises: searching among groups to which said audio/video device belongs to, and/or searching among all groups of the network.

In this way, a search is limited to the certain groups thereby saving bandwidth as not the entire network is queried, or a search is done by querying the entire potentially giving more hits/results but using a larger amount of total bandwidth.

In one embodiment, the related information comprises metadata annotated to said digital content item.

In one embodiment, the digital content item currently being rendered: is a pre-recorded or downloaded content item obtained from a local storage of said audio/video device, and/or is a pre-recorded or downloaded content item obtained from an additional audio/video device via said network, and/or is a content item obtained via live broadcast.

In one embodiment, the network is a peer-to-peer network and/or said audio/video device is a hard disk recorder (HDR) or personal video recorder (PVR).

In one embodiment, the group is a virtual private network (VPN) comprising content items relevant for said group of all the users belonging to that particular group.

Advantageous embodiments of the device according to the present invention are defined in the sub-claims and described in detail in the following. The embodiments of the device correspond to the embodiments of the method and have the same advantages for the same reasons.

Further, the invention also relates to a computer readable medium having stored thereon instructions for causing one or more processing units to execute the method according to the present invention.

These and other aspects of the invention will be apparent from and elucidated with reference to the illustrative embodiments shown in the drawings, in which:

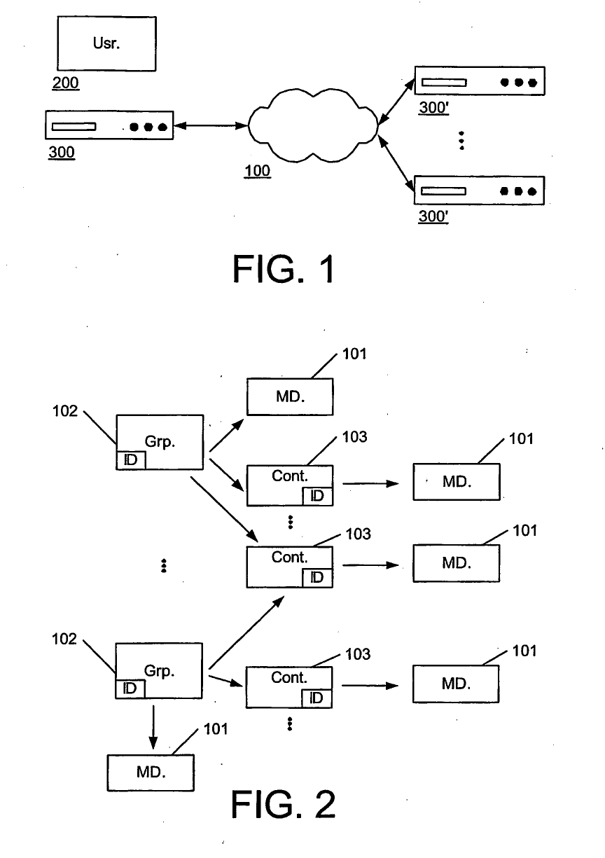

FIG. 1 schematically illustrates how a device according to the present invention communicates with additional devices via a network according to the present invention;

FIG. 2 schematically illustrates a relationship between content item(s), group(s), and metadata;

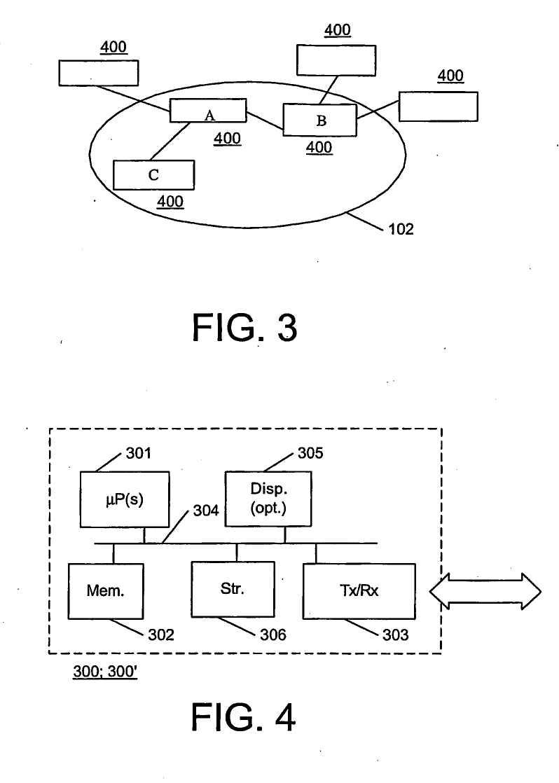

FIG. 3 schematically illustrates a number of peers of a peer-to-peer network, where some peers belong to the same group; and

FIG. 4 schematically illustrates a device according to one embodiment of the present invention.

FIG. 1 schematically illustrates how a device according to the present invention communicates with additional devices via a network according to the present invention. Shown are a user (200), an audio/video device (300), and at least one additional audio/video device (300′), where the audio/video device (300) is connected via a network (100) to the at least one additional audio/video device (300′).

A content item may be any one of several types of content, such as television programs/shows, movies, radio programs, audio and/or video tracks, MPEG-4 objects, scenes, images, music, etc. The content item may e.g. be rendered/accessed from a local storage (i.e. pre-recorded or downloaded in e.g. a memory and/or on a hard disk) in the device, from an additional/another device (300′) connected in the network (100) or be received from a live broadcast e.g. from a content provider, etc.

The audio/video device (300) and the at least one additional audio/video device (300′) may e.g. be HD recorders, PVRs/PVSs (Personal Video Recorders/Personal Video Stations), DVB (Digital Video Broadcasting) systems, DVRs (Digital Video Recorders), PTRs (Personal TV Receivers), DVD/CD recorders/players, etc. They do not have to be identical or of the same type.

Preferably, the network (100) is a peer-to-peer network as is well known in the prior art, whereby the audio/video device (300) can reach the additional devices without being connected directly to all of them but instead using other additional devices as intermediate connection points or nodes as in traditional peer-to-peer network setups. Other devices than audio/video devices (300; 300′) may also be connected to the network.

According to the present invention, when a user (200) is watching or has selected a content item (not shown; see e.g. 103 in FIG. 2) on the audio/video device (300) (or the content item simply is being rendered or accessed by or on the device (300)) then the user (200) indirectly provides the device (300) with an amount of interesting related information (not shown; see e.g. 101 in FIG. 2). The related information may be automatically derived or obtained by the device (300) from metadata, pairs of attributes and values, etc. linked or annotated with the content item being rendered and/or one or more groups comprising the content item being rendered. The device may then use this related information to search for and locate other groups that to a high degree also will interest the user, as explained in the following.

A group designates a number of content items having at least one characteristic in common. Examples of groupings are e.g. same genre like comedy, news, action, etc. or some security criteria like only certain people allowed, etc. or user specified groups like my_home_videos and so on. The relationship between group(s), metadata, and content item(s) is described in greater detail in connection with FIG. 2.

Examples of such related information is e.g. metadata keywords in the well-known TV Anytime data format, the well-known MPEG 7 Multimedia Description Scheme (MDS)/MPEG 7 Standard or in general pairs of attributes and values, etc.

After the device (300) has obtained or derived the related information it searches the network (100) for groups that contain the currently selected/viewed/rendered content item (or a copy thereof). As these groups also comprise the content that the user is viewing there is a high probability that the user also will find these groups and the other content in them interesting.

Assuming that each content item (and each group) has a unique identifier (see e.g. FIG. 2) such a query is very straightforward, especially in a peer-to-peer network.

In a preferred embodiment, the search is initiated in the background when rendering or selection of the content item is started so that a result of said search at least more likely is ready when a user requests the result, i.e. the search is done transparently to the user while the user is being presented or selects the content item. In this way, it is possible to provide the user with (lists or the like of) groups and/or content that to a high degree interests the user based on the content item the user currently is viewing and it is possible to do this very fast as the search most likely already has been done before the user actually request a search.

According to other aspects of the present invention, the related information/the metadata may also be used to extend or elaborate a search.

According to one aspect, the device (300) searches the network for groups and/or content that is similar to the currently watched, rendered, selected, etc. Preferably, this is done by obtaining and selecting several fields of metadata from the content item currently being watched, etc. and then performing a search for groups/content on additional devices matching this metadata. This would provide the user with a list of groups and/or content that results from a broader search, as groups/content having similarities in some fields (e.g. actor, genre, language, etc.) would be returned instead of only groups comprising the same content item as currently being watched.

According to another aspect of the present invention, the device (300) could also assist a user by pre-filling or initially filling fields to be searched for. I.e. when a user wishes to start a search of content/groups among the devices connected to the (peer-to-peer) network, then the fields to search for is filled with metadata/related information from the currently watched, rendered, accessed, etc. content item. The fields could e.g. relate to the given genre, language, actor of the content currently being viewed, etc. In this way, a user can easily (de)select the relevant options. I.e. the user only has to modify the proposed search fields by specifying to include a given field in the search or not. This modification or deselecting/selecting can be done by a very simple user interface and without the use of a keyboard or similar complex input device for getting input. This is especially useful for devices being operated by simpler means, such as a remote control or the like.

FIG. 2 schematically illustrates a relationship between content item(s), group(s), and metadata. Shown are one or more groups (Grp.) (102), one or more content items (Cont.) (103), and one or more pieces of metadata (MD.) (101).

Preferably, each content item (103) (and copies thereof, e.g. stored on other devices) comprises a unique identifier (ID) identifying that particular content item. Such identifiers may e.g. be the well known TV Anytime CRID or a similar construct.

Metadata (101) is in this context descriptive data about content or groups. Examples are e.g. a program title, synopsis, genre, language, actor(s) in the specific content item, my home_videos, etc. Typically metadata of a group or of a content item comprises many different fields/descriptive data items. Such metadata may e.g. be implemented in XML (eXtended Meta Language) or similar and even non-XML type representations e.g. encoded in a binary format for transmission and/or storage.

Groups (102) comprise one or more content items (103) (as indicated by the arrow between them) having at least one characteristic in common. Examples are e.g. comedy, news, my_tennis_club, rock, my_home_videos, etc. Each group also comprises an identifier uniquely identifying that group. A group is not a physical group of devices, but rather a more dynamical concept, where a group may be created by a single user, while other users can join and leave. Typically, users are not aware of other members of the group, but a user belonging to a certain group is able to search among the contents of the other users of that group. A preferred concept of groups is explained in greater detail in connection with FIG. 3.

As indicated by arrows, each group (102) and each content item (103) preferably has associated metadata (MD) (101).

As illustrated, a group may contain multiple content items and a given content item may belong to more than one group.

The use of these elements according to the present invention has been explained above.

FIG. 3 schematically illustrates a number of peers of a peer-to-peer network, where some peers belong to the same group. Illustrated is a group (102) comprising a number (in this particular example three) of peers (400). A peer is often a device. Alternatively, a peer could be a representation of a user, e.g. a user ID or a session ID related to a user, depending on whether the P2P network is device based or user based. Such a representation of a user including all user properties, e.g. also content linked or belonging to the user, may be dynamically established or deleted depending on the availability of the user in the network. A network could also comprise a mix of user-based and device-based peers. In general, a peer can be a combination of one or more representation of users and/or one or more devices.

As mentioned, a group (102) is not a physical group of devices but rather a group may be seen as a virtual private network (VPN), where the VPN, i.e. the group, comprise the content relevant for the group of all the users belonging to that particular group.

The search for relevant content according to the present invention may e.g. be done within a single group or e.g. within the entire network. Due to the distributed nature of P2P networks a search query initiated by a peer is distributed to a number of peers where each returns their result but also distribute the search query to additional peers, etc. As an example, peer ‘C’ initiate a search query for a content item or a group. This query is then forwarded or sent to peer ‘A’ which provides its (local) result to the query (i.e. the content items and/or groups stored on or reachable by a device of peer ‘A’) and also forward the query to peer ‘B’ and a peer outside the group/VPN (102). Peer ‘B’ (and the peer outside the group) returns its local result and forward the query to two peers outside the group/VPN (102).

If the search is only to be done within a single group peer ‘A’ only forwards to peer ‘B’ and peer ‘B’ does not forward it to any other peer (as every peer within the group/VPN has received the query).

As one exemplary use scenario of the present invention, please consider the following:

A user (peer) is currently watching or has selected a content item, e.g. a program, and his device, e.g. a HD recorder, then queries the whole network (i.e. the physical network comprising several groups/VPNs) in order to locate groups containing this content item being viewed, e.g. using the unique identifier of the content item. In this way, all existing groups (reachable by the physical network within a suitable time limit) containing this content item is be located. These groups will more likely contain similar interesting and relevant content. A drawback of this approach is that a relatively large amount of bandwidth is used since the whole network is queried for each query of each device of the network, i.e. each time a user watches/hears or selects a content item on a device.

In this simple example, all six peers (400) would be queried.

As another example, please consider:

A user (peer) is currently watching a content item, e.g. a program, and his device, e.g. a HD recorder, then queries the groups (e.g. VPNs) to which the user belongs to in order to locate groups containing this content item being viewed, e.g. using the unique identifier of the content item. A drawback is that perhaps not all groups are located since not all users/peers are queried (i.e. the users/peers not belonging to the group is not queried). However, since the query is done among groups to which the user belongs there is a bigger chance that there will be significant/relevant results. In addition, since the query is only sent to users in the group, this is a very scalable solution.

In this simple example, the peers (400) labeled ‘A’, ‘B’, and ‘C’ and peers of other groups that the user belongs to (not shown) would be queried.

FIG. 4 schematically illustrates a device according to one embodiment of the present invention. Shown is a device (300; 300′) comprising or having access to one or more digital content items, one or more groups, and one or more pieces of related information/metadata arranged as previously described e.g. in connection with FIG. 2.

The device (300; 300′) comprises a memory (302) and/or a storage (306) for short and/or long term storage of data, information, intermediate data, etc., communication means (303) e.g. for sending/receiving content items, groups, and/or metadata/related information, and optionally a display (305) for presenting content items (104) to a user. The device (300; 300′) further comprises one or more general and/or special purpose microprocessors (301) for automatically obtaining related information/metadata and performing a search according to the present invention as described earlier and in connection with FIGS. 1, 2 and 3.

The various units may communicate via a data/information bus (304) or similar type of structures.

In the claims, any reference signs placed between parentheses shall not be constructed as limiting the claim. The word “comprising” does not exclude the presence of elements or steps other than those listed in a claim. The word “a” or “an” preceding an element does not exclude the presence of a plurality of such elements.

The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method of searching for relevant content, said method comprising the steps of:
automatically obtaining related information (MD; 101; ID) for a digital content item (103) currently being rendered or selected on an audio/video device (300), and
establishing a communications connection with at least one additional audio/video device (300′) via a network (100), and
using said related information (MD; 101; ID) to automatically search via said additional audio/video device (300′) for groups (102) comprising said digital content item (103).

2. A method according to claim 1, wherein said method further comprises, when a user (200) manually initiates a search for one or more content items (103) and/or groups (102) where the search comprises one or more fields to search for, the step of:
specifying one or more initial values for each field using said related information (MD; 101), where the user (200) may, for each field, select among the initial values if more than two initial values for a single field and/or may de-select the use of initial values for a single field.

3. A method according to claim 1, wherein said search is initiated in the background when rendering or selection of the content item is started so that a result of said search at least more likely is ready when a user requests the result.

4. A method according to claim 1, wherein said step of using said related information (MD; 101; ID) to automatically search for groups (102) comprises:
searching among groups (102) to which said audio/video device (300) belongs to, and/or
searching among all groups (102) of the network (100).

5. A method according to claim 1, wherein said related information (MD; 101) comprises metadata (MD; 101) annotated to said digital content item (103).

6. A method according to claim 1, wherein said digital content item (103) currently being rendered:
is a pre-recorded or downloaded content item obtained from a local storage (302; 306) of said audio/video device (300), and/or
is a pre-recorded or downloaded content item obtained from an additional audio/video device (300′) via said network (100), and/or
is a content item obtained via live broadcast.

7. A method according to claim 1, wherein said network (100) is a peer-to-peer network and/or said audio/video device (300) is a hard disk recorder (HDR) or personal video recorder (PVR).

8. A method according to claim 1, wherein said group (102) is a virtual private network (VPN) comprising content items (103) relevant for said group of all the users (200) belonging to that particular group.

9. A device for searching for relevant content, said device comprising:
means (301) for automatically obtaining related information (MD; 101; ID) for a digital content item (103) currently being rendered or selected on an audio/video device (300), and
a communications transceiver (303) for establishing a communications connection with at least one additional audio/video device (300′) via a network (100), and
means (301) for using said related information (MD; 101; ID) to automatically search via said additional audio/video device (300′) for groups (102) comprising said digital content item (103).

10. A device according to claim 9, wherein said device further comprises means (301) for, when a user (200) manually initiates a search for one or more content items (103) and/or groups (102) where the search comprises one or more fields to search for: specifying one or more initial values for each field using said related information (MD; 101), where the user (200) may, for each field, select among the initial values if more than two initial values for a single field and/or may de-select the use of initial values for a single field.

11. A device according to claim 9, wherein said search is initiated in the background when rendering or selection of the content item is started so that a result of said search at least more likely is ready when a user requests the result.

12. A device according to claim 9, wherein said means (301) for using said related information (MD; 101; ID) to automatically search for groups (102) is adapted to:
search among groups (102) to which said audio/video device (300) belongs to, and/or
search among all groups (102) of the network (100).

13. A device according to claim 9, wherein said related information (MD; 101) comprises metadata (MD; 101) annotated to said digital content item (103).

14. A device according to claim 9, wherein said digital content item (103) currently being rendered:
is a pre-recorded or downloaded content item obtained from a local storage (302; 306) of said audio/video device (300), and/or
is a pre-recorded or downloaded content item obtained from an additional audio/video device (300′) via said network (100), and/or
is a content item obtained via live broadcast.

15. A device according to claim 9, wherein said network (100) is a peer-to-peer network and/or said audio/video device (300) is a hard disk recorder (HDR) or personal video recorder (PVR).

16. A device according to claim 9, wherein said group (102) is a virtual private network (VPN) comprising content items (103) relevant for said group of all the users (200) belonging to that particular group.

17. A computer readable medium having stored thereon instructions for causing one or more processing units to execute the method according to claim 1.
